(19) United States
(12) Patent Application Publication
(10) Pub. No.: US 2018/0241577 A1
(43) Pub. Date: Aug. 23, 2018

(54) Proximity-Based Security

(71) Applicant: Digital Kerosene Inc., Pasadena, CA (US)

(72) Inventors: Carey D'Souza, Pasadena, CA (US); Ali Ayazi, Santa Monica, CA (US); Jeshua Nanthakumar, Fremont, CA (US)

(21) Appl. No.: 15/900,797

(22) Filed: Feb. 21, 2018

Related U.S. Application Data
(60) Provisional application No. 62/461,783, filed on Feb. 21, 2017.

(51) Int. Cl. H04L 12/08; H04L 29/06; H04L 12/06

(52) U.S. Cl. CPC H04L 12/08; H04L 63/0861; H04L 12/06; H04L 63/102; H04L 63/0492

(57) ABSTRACT

In one embodiment, a first computing device may establish a spatial gap, wherein the spatial gap is defined by a maximum distance from the first computing device for computing devices requesting validation of credentials. The first computing device may then exchange with a second computing device, data transmissions to execute a handshake protocol, wherein the first computing device transmits communication signals at a specified signal strength, and wherein the specified signal strength is configured based on the maximum distance. The first computing device may then determine that the second computing device remained within the spatial gap throughout the handshake protocol, and then grant access to the second computing device.

### PRIORITY

This application claims the benefit, under 35 U.S.C. § 119(e), of U.S. Provisional Patent Application No. 62/461,783, filed 21 Feb. 2017, which is incorporated herein by reference.

### TECHNICAL FIELD

This disclosure generally relates to enforcing security requirements.

### BACKGROUND

Conventional authentication systems rely on BLUETOOTH, Wi-Fi, cellular networks (SMS/call) or additional hardware to transmit transactional or authentication data. In most cases, the user is required to explicitly provide some user input in order to complete the authentication process or to validate the transaction. This makes these methods vulnerable and cumbersome to use. Also, there is no guarantee that the rightful person is entering the code and not an imposter who has stolen the code or authentication data. There is no way of ensuring that the user who is completing the authentication is physically present at the time of the actual transmission or data exchange.

Access to a restricted system may enforce upon a user the burden of proving their identity and authority to access said system. When a user desires access to a restricted system, they must meet the access criteria specified by the system. This may include one or more methods of proving the user's identity and may also include one or more methods of proving the user's authority to access the system. Proving the user's identity is solely the burden of the user. Proving the authority may be the burden of the user, or may be provided by the system by storing the rights, privileges or access credentials of the identified user in the system database.

Historically, enforcing strong security protocols that consider both the user's identity and authority have been very cumbersome, inconvenient, slow to implement, hard to enforce and as a consequence, users frequently find methods to cheat or bypass the provided security protocols. These “cheats” may be achieved by simple means and they completely subvert strong security protocols. Examples include; 1) bypassing strong and complex password security by a user writing their password on a note and displaying their password in a visible place, such as on their computer screen, and 2) bypassing physical location security protocols such as “secured doors and gates” by the user “tailgating”—the practice where an unauthorized user follows an authorized user closely and passes through a physical barrier after the authorized user has passed the security point.

### SUMMARY OF PARTICULAR EMBODIMENTS

Particular embodiments provide a method for creating a secure environment between a mobile/wearable device and an access point or between multiple devices by collecting and securely transmitting encrypted data that can be used to identify an individual in real-time. This encrypted authentication data is communicated via acoustic, optical, or electromagnetic means. Any of these means or a combination of two or all three of them could be used for communication.

The device used to collect and transmit data used for authentication may be any device that has sufficient capabilities to collect, send and receive data. Such devices may include, by way of example and not limitation. smartphones, personal and desktop computers, other hardware, or any devices capable of digital communications (e.g., devices belonging to the “Internet of Things”).

The device used to receive the authentication data may be equipped with a component to receive acoustic, optical, or electromagnetic data such as, by way of example and not limitation: a microphone, a speaker, a camera, an electromagnetic transmitter/receiver (including but not limited to BLUETOOTH, Wi-Fi, or NFC), or another appropriate component.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A and 1B are visual representations of acoustic or audible communications between a first computing device and a second computing device.

FIGS. 2A-2D are visual representations of acoustic or audible communications between a cellular phone/wearable device and a laptop.

FIGS. 3A and 3B are visual representations of acoustic communications between a cellular phone/wearable device and an access control panel/protected source such as an ATM, vending machine, automobile, etc.

FIGS. 4A and 4B are visual representations of acoustic communications between a cellular phone/wearable device and a tablet computer.

FIGS. 5A-5E illustrate an example authentication process according to a particular embodiment.

FIG. 6 illustrates collection of reference signals by two example devices.

FIG. 7 illustrates an example method of synchronization between two devices.

FIG. 8 illustrates an example method of transmitting and receiving authentication signals along with a reference signal.

FIG. 9 is a schematic illustrating an authentication process using acoustic means within a defined spatial gap.

FIG. 10 is a schematic illustrating an authentication process using electromagnetic means within a defined spatial gap.

FIG. 11 is a schematic illustrating an authentication process using optical means within a defined spatial gap.

FIG. 12 is a schematic illustrating an authentication process using a mix of communications means within a defined spatial gap.

FIG. 13 is a schematic illustrating an authentication process taking place over layered spatial gaps.

FIG. 14 illustrates an example computer system.

### DESCRIPTION OF EXAMPLE EMBODIMENTS

Particular embodiments provide a method for creating a secure environment between a mobile/wearable device and an access point or between multiple devices by collecting and securely transmitting encrypted data that can be used to identify an individual in real-time. This encrypted authentication data is communicated via acoustic, optical, or electromagnetic means. Any of these means or a combination of two or all three of them could be used for communication. Acoustic means may include ultrasonic, audible and hypersonic frequencies.

The device used to collect and transmit data used for authentication may be any device that has sufficient capabilities to collect, send and receive data. Such devices may include, by way of example and not limitation: smartphones, personal and desktop computers, other hardware, or any devices capable of digital communications (e.g., devices belonging to the “Internet of Things”).

The device used to receive the authentication data may be equipped with a component to receive acoustic, optical, or electromagnetic data such as, by way of example and not limitation: a microphone, a speaker, a camera, an electromagnetic transmitter/receiver (including but not limited to BLUETOOTH, Wi-Fi, or NFC), or another appropriate component.

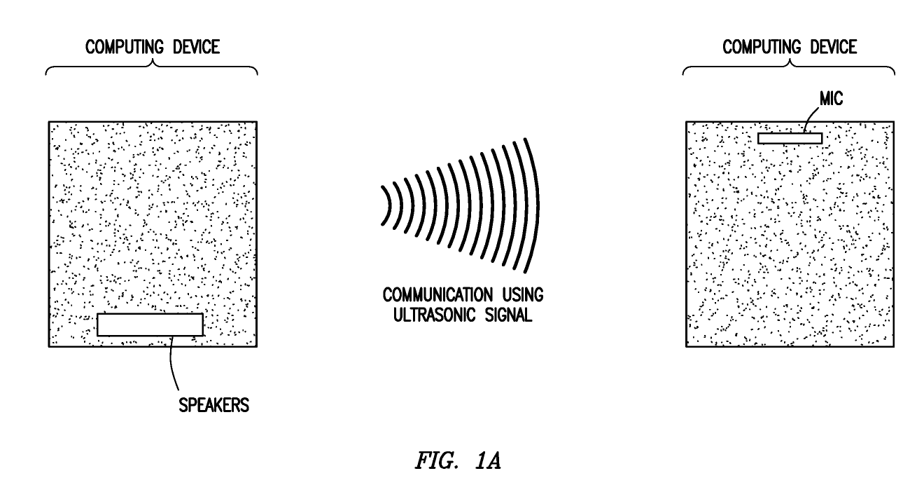

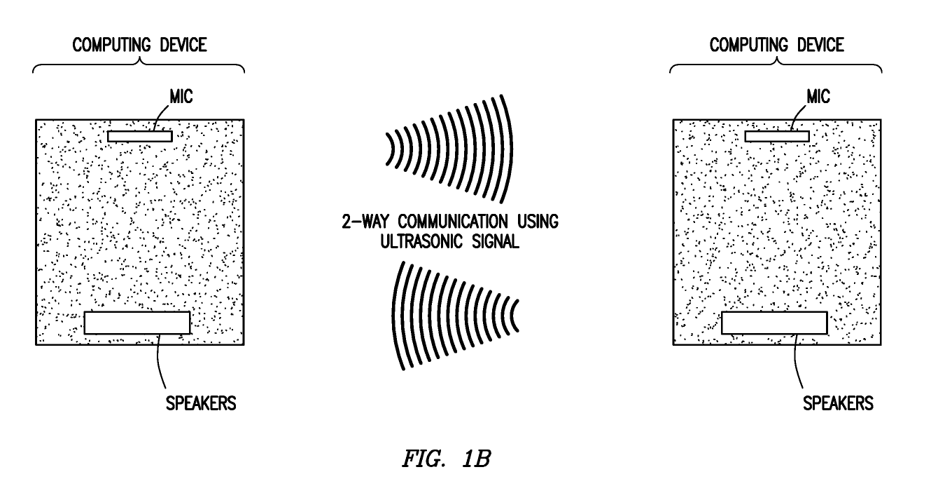

FIGS. 1A-4B are detailed diagrams of various devices communicating with each other using acoustic frequencies. Mobile/wearable device emits the acoustic sound from its speakers and the receiving device picks up this signal via its microphone and sends back a verification code acoustically. In particular embodiments, an identity authentication software uses acoustic patterns via a mobile/wearable device to authenticate a user's identity (e.g., in place of using email and/or username and password combinations). For example, the identity authentication software may be used for email, website, network, and device authentication. In particular embodiments, data may be exchanged using acoustic frequencies without the need for BLUETOOTH, wireless or network connectivity. In addition, the number of interactions required by the user during the authentication process may be reduced. The embodiments discussed herein may be used in other applications for mobile devices, personal computers, laptops, cellular phones, wearable devices, healthcare applications, IT applications, access control panels for ATMs, automobiles, and vending machines, and other suitable applications.

In particular embodiments, the surrounding ambient noise is filtered out using, for example, algorithms that identify the acoustic signal from the noise. In particular embodiments, the 20-22 kHz range may be used to minimize ambient noise.

FIGS. 1A and 1B show example embodiments of acoustic communications between a first computing device and a second computing device. In FIG. 1A, a first computing device A may hold or generate data that can be used to access a protected resource on a second computing device B. First computing device A may encode the data and use it to modulate an acoustic signal that is transmitted from first computing device A's speaker. Second computing device B may comprise a decoder that is running software that is listening for a suitably encoded signal in a pre-defined acoustic frequency range. On detection of suitable data, the decoder of second computing device B may begin decoding the transmitted data until all required data has been decoded. At this point the software running on second computing device B is in possession of the data required to access the protected resource on second computing device B. In particular embodiments, the communication channel may be unidirectional.

FIG. 1B is essentially the same as FIG. 1A, except that it illustrates that a bi-directional acoustic communication channel may be created. Third computing device C may modulate an acoustic signal with the data required by fourth computing device D and transmit the signal using its speaker. Fourth computing device D may run software that is listening for properly formatted data in a given frequency range using its microphone. On detection of a properly formatted signal, fourth computing device D may decode and use the transmitted data. Fourth computing device D may use the same method to send data to third computing device C, which uses the same detection system to decode data. Steps are taken to allow third computing device C and fourth computing device D to each transmit and receive data at the same time.

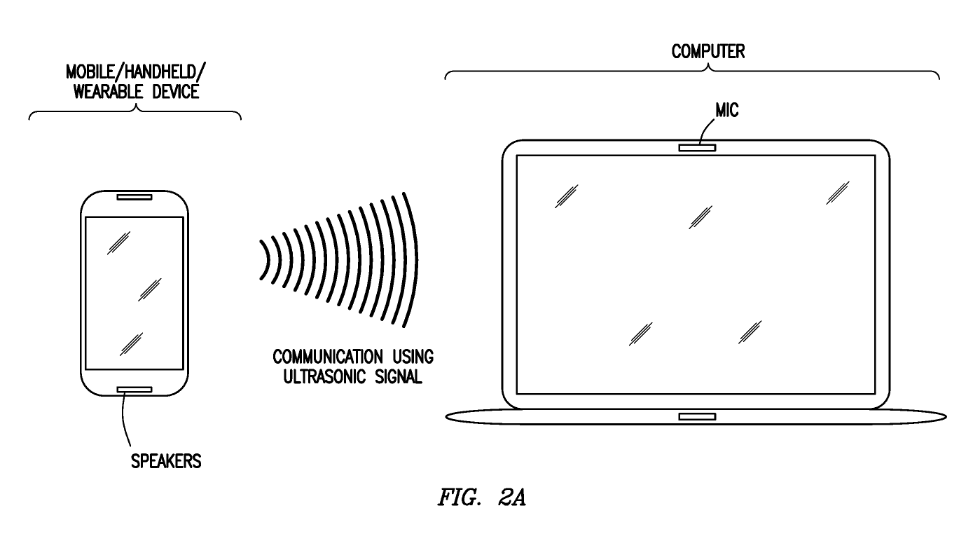

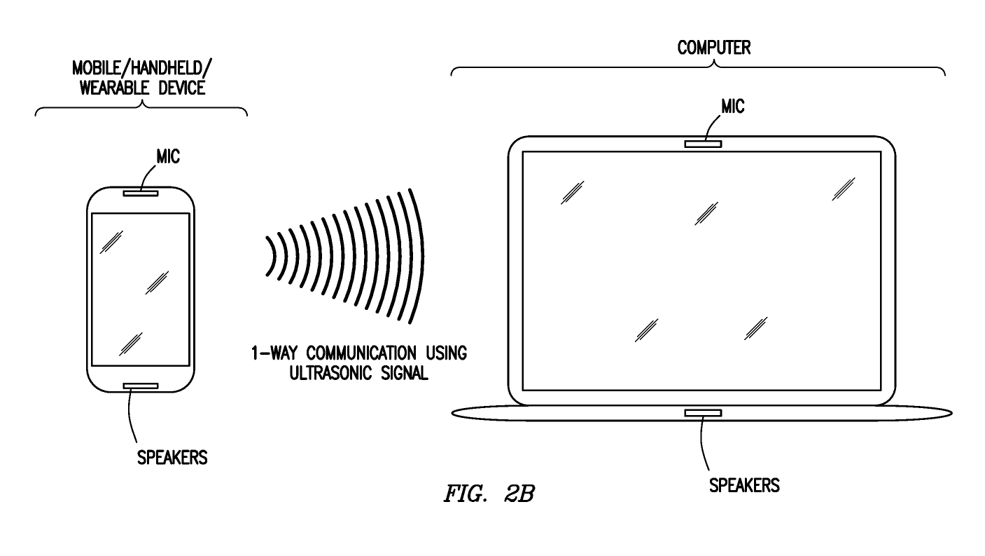

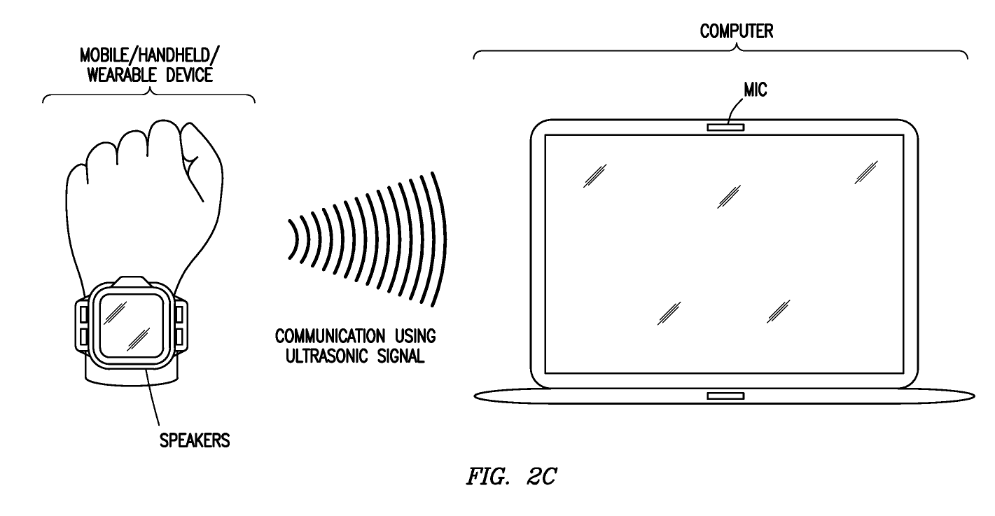

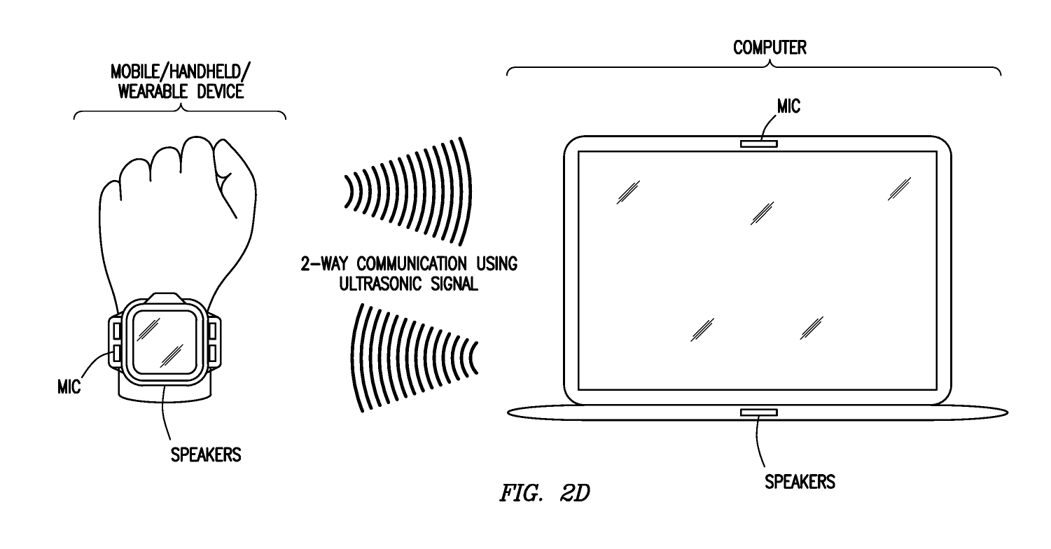

FIGS. 2A and 2B show example embodiments of acoustic communications between a cellular phone and a laptop. FIGS. 2C and 2D show example embodiments of acoustic communications between a wearable device and a laptop. FIGS. 2A and 2B illustrate physical examples of the theoretical model presented in FIGS. 1A and 1B using example currently available computing devices.

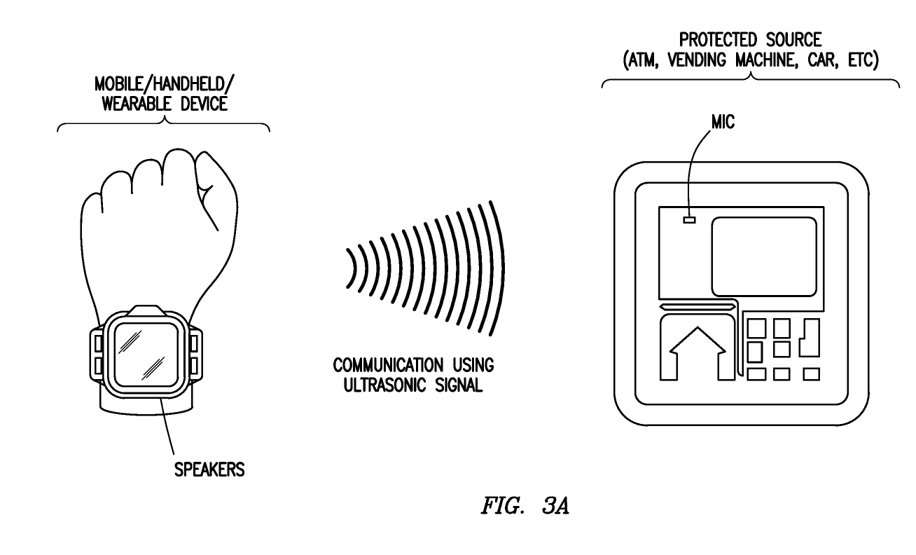

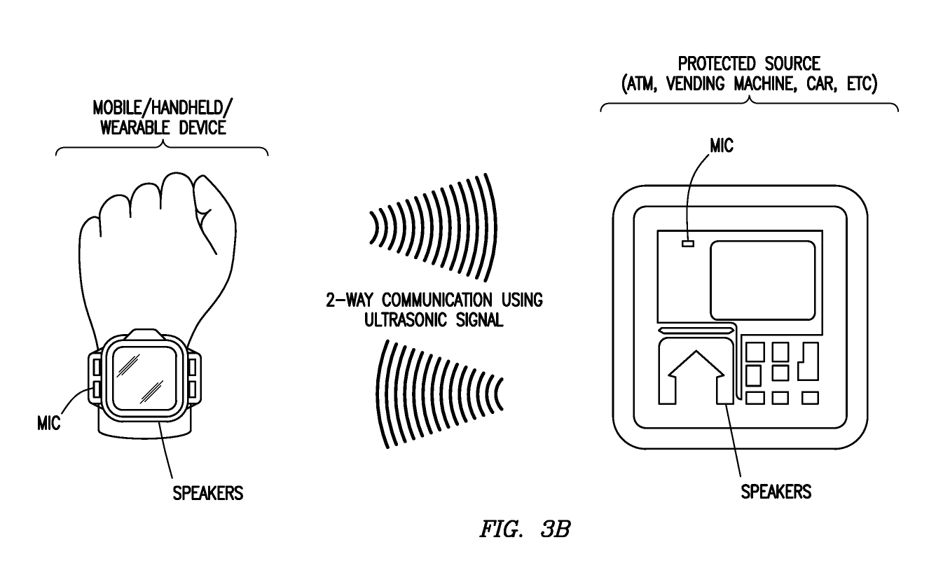

FIGS. 3A and 3B show example embodiments of acoustic communications between a wearable device and an example access control panel. FIGS. 3A and 3B illustrate physical examples of the theoretical model presented in FIGS. 1A and 1B using example currently available computing devices.

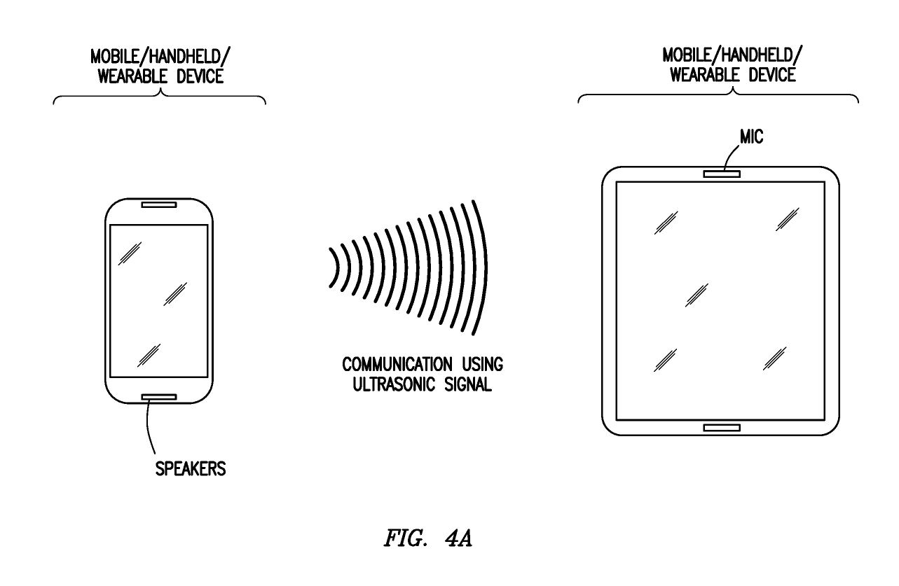

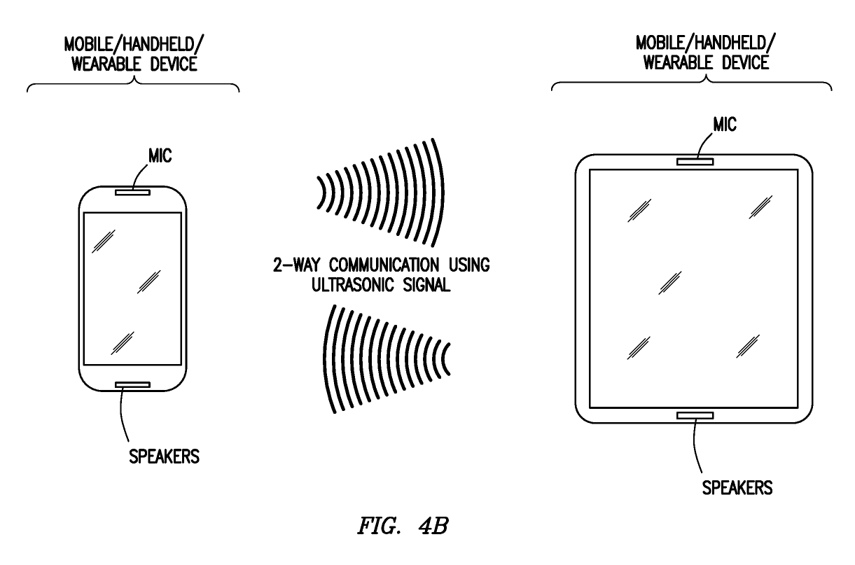

FIGS. 4A and 4B show example embodiments of acoustic communications between a cellular phone and a tablet computer. FIGS. 4A and 4B illustrate physical examples of the theoretical model presented in FIGS. 1A and 1B using example currently available computing devices.

In particular embodiments, the first computing device A, second computing device B, or a combination of first computing device A and second computing device B (and similarly, third computing device C, fourth computing device D, or a combination of third computing device C and fourth computing device D) may comprise a transmitter and a receiver. The transmitter may encode data and generate acoustic signals with data as payload. The receiver may listen for acoustic signals and extract payload, and then use the data for a task. As an example and not by way of limitation, first computing device A may comprise a transmitter and second computing device B may comprise a receiver.

In particular embodiments, the transmitter may comprise instructions for providing a user interface (“UI”) that allows a user to enter information that is used to provide access to a secured resource (e.g., secured data). The user may retrieve this information from third party service providers (e.g., Google) in the form of a username and secret token. As an example and not by way of limitation, the token may be used as the seed for a time-based one-time password (TOTP) generation algorithm. The secret token may be stored on the device running the transmitter software (e.g., a smartphone) using secure storage provided by the device's operating system.

In particular embodiments, the transmitter may provide a UI that allows the user to select a service and transmit a one-time code. The one-time code (e.g., a secret number) may be read from secure storage and used to generate an access code using instructions that run on the local device (e.g., instructions that run entirely on the local device, instructions that run on a separate server, instructions that run on a separate external device). In particular embodiments, the one-time code and current time may be used as input to a library that generated TOTP codes. In particular embodiments, the code may then be added to a formatted message and transmitted using an audio output device (e.g., which may be internal or external).

In particular embodiments, the message sent by the transmitter may comprise a fixed alphabet in additional to special control characters. As an example and not by way of limitation, the message may include the characters below and their corresponding purposes:

| Character | Purpose |
|---|---|
| {S} | start of message |
| {E} | end of message |
| {D} | duplicate character separator |

In particular embodiments, additional information may be encoded with the instructions, the length of the instructions, and an XOR checksum. As an example and not by way of limitation, the encoding messaging may have the format:

message=[start control character][code length] code[checksum][end control char]

In particular embodiments, Consecutive duplicate characters are separated by a duplicate character separator ({D}). For example, instructions (e.g., code) that reads “112233” may be encoded as “1{D}12{D}23{D}3”. In particular embodiments, the checksum may be a XOR checksum. In particular embodiments, the final checksum may undergo a bitwise AND operation with 63 Hex so that it will fit into two numeric decimal characters, and preceding zeros are included in the checksum (e.g., when checksum=1, encoded checksum=01).

In particular embodiments, an additional encryption stage may be applied to the formatted message. The encryption algorithm can be varied based on deployment requirements.

In particular embodiments, the acoustic signal may be encoded using a Single Tone Multi Frequency algorithm. As an example and not by way of limitation, a fixed alphabet may be defined that includes the characters used to define codes plus control characters to identify the start and end of the message and to separate duplicate characters. As an example and not by way of limitation, each transmittable character is assigned a frequency within a predefined frequency range, as shown below:

| Character | Frequency kHz |
|---|---|
| {S} (start of message control character) | 19 |
| 0 | 19.1 |
| 1 | 19.2 |
| 2 | 19.3 |
| 3 | 19.4 |
| 4 | 19.6 |
| 6 | 19.6 |
| 6 | 19.7 |
| 7 | 19.8 |
| 8 | 19.9 |
| 9 | 20.0 |
| {D} (separates duplicate characters) | 20.1 |
| {E} (end of message control character) | 20.2 |

In particular embodiments, the formatted message is transmitted in a serial manner (one character at a time). As an example and not by way of limitation, a sine wave with the frequency corresponding to the current character may be generated for a predetermined length of time. The length of the pulse may be configured by the transmitting software. Once a character pulse has been output for the correct amount of time the next character in the message may be sent until all data has been sent. As an example and not by way of limitation, for the code 123466, the message for this code will be {S}61234663{D}3{E} as shown below:

| Time | Character | Frequency kHz |
|---|---|---|
| 0 | {S} | 19.0 |
| 0.1 | 6 | 19.7 |
| 0.2 | 1 | 19.2 |
| 0.3 | 2 | 19.3 |
| 0.4 | 3 | 19.4 |
| 0.6 | 4 | 19.6 |
| 0.6 | 6 | 19.6 |
| 0.7 | 6 | 19.7 |
| 0.8 | 3 | 19.4 |
| 0.9 | {D} | 20.1 |
| 1.0 | 3 | 19.4 |
| 1.1 | {E} | 20.2 |

In particular embodiments, the software may be configured to send the message multiple times. In particular embodiments, the software may provide a mechanism for client software and users to control the output volume. In particular embodiments, the software may provide a mechanism for controlling ramp up and ramp down behavior for the pulses and for inserting periods of silence between pulses. In particular embodiments, the sound pulses may be generated at runtime or be pre-rendered audio data (files).

In particular embodiments, the receiver may be responsible for detecting the acoustic signal, decoding the data (e.g., by a decoder), and performing an action. In particular embodiments, the receiver may use the same fixed alphabet, control characters and frequency range.

In particular embodiments, the receiver software may request access to the system microphone on a system or device either in response to user input (e.g., the user clicks a button), or automatically by detecting situations in which it should listen (e.g., a web browser opening a particular web link URL). In particular embodiments, the receiver software may be a standalone executable software, an add on for existing software (e.g., a browser plugin), or any other suitable software. In particular embodiments, upon activation the receiver may continuously read input from a microphone attached to a host device.

In particular embodiments, the decoder may be responsible for detecting frequency peaks at the frequencies corresponding to the characters sent by the transmitter. In particular embodiments, the receiver may convert sampled audio data from the OS into the frequency domain. The algorithm used for performing this transformation may be a fast Fourier transform, other time-to-frequency domain conversion algorithms, or other suitable algorithms, to optimize performance for specific situations. In particular embodiments, the receiver continuously checks the received data for peaks at any of the frequencies that match the characters sent by the transmitter. A configurable frequency error range (“FERR”) may be allowed such that a peak within FERR of one of the predefined frequencies is considered a match. In particular embodiments, the value of FERR may be configurable. As an example and not by way of limitation, the peaks with the largest magnitude may be found and their magnitudes compared to a configurable threshold value. In particular embodiments, if the magnitude is large enough the peak may be added to a history. As an example and not by way of limitation, to be considered a peak that represents a character a frequency peak must have been present for a certain number of iterations. The number of iterations may be configurable. The peak may now be considered to be “valid.”

In particular embodiments, once a “valid” peak has been detected, the receiver may convert the peak to the “alphabet domain.” If the peak represents a character in the alphabet, serial decoding of the message begins.

In particular embodiments, the message may be contained between start and end control signals (e.g., {S} and {E}, respectively). In particular embodiments, the receiver may have two states: an idle state (e.g., waiting for a start control character), and a working state (e.g., reading data, waiting for end character). Upon detecting the start character, the receiver may switch to the working mode and may read consecutive peaks and add them to a message buffer. If no peaks are detected within a configurable timeout period the receiver may return to the idle state.

In particular embodiments, when the receiver detects the end character, the receiver may start performing error checking on the message by checking that the length of the data matches the message, and/or checking that the transmitted checksum matches a locally calculated checksum. If both conditions are satisfied, the data may be passed to software that can use the data. As an example and not by way of limitation, the receiver may use the data to populate a field in a web page.

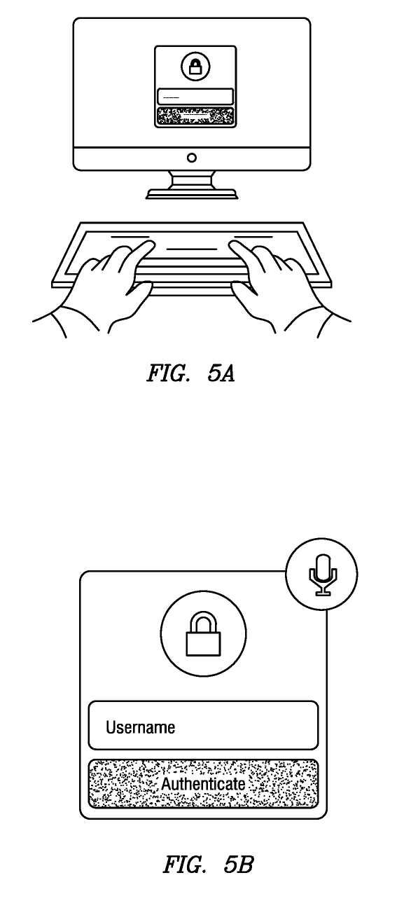

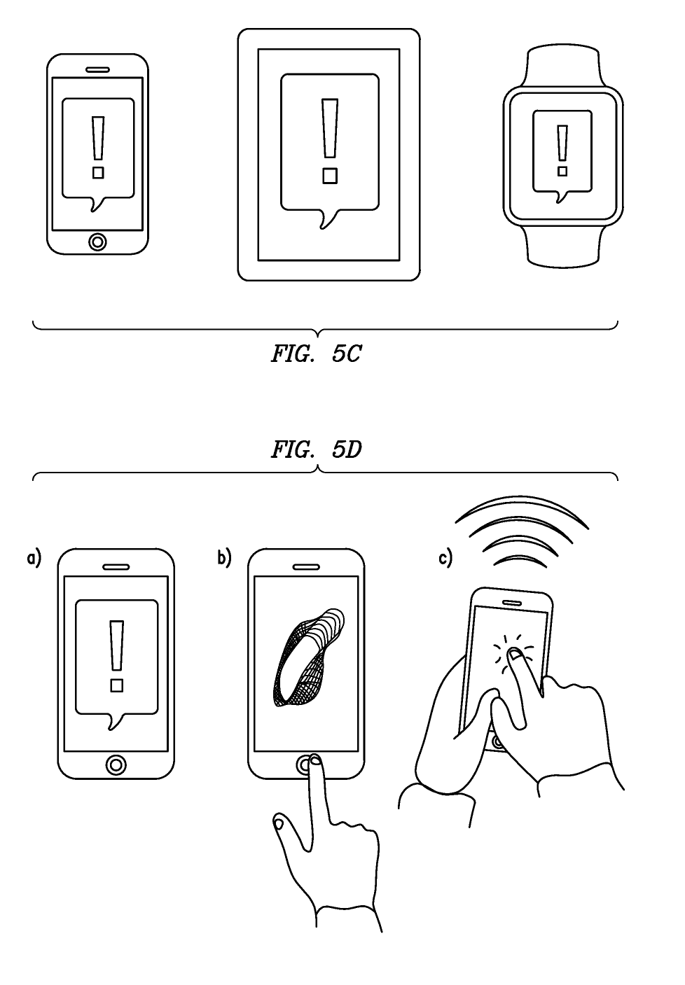

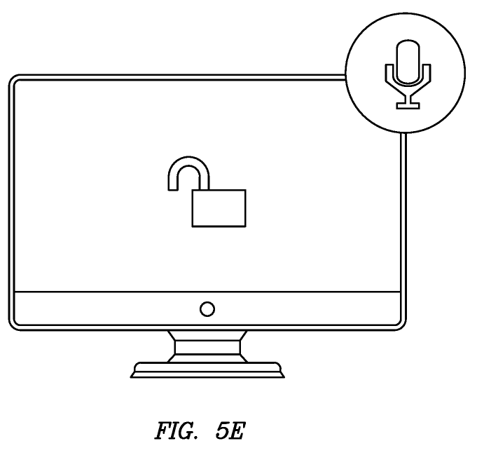

FIGS. 5A-5E illustrate an example authentication process according to a particular embodiment. As shown in FIG. 5A, the user may attempt to access a website on a computer that is equipped with a microphone. As shown in FIG. 5B, the user may type in a username, and then may click on an “authenticate” button. Then, computer “listens” for the inputted username and user-requested authentication (e.g., by a browser plugin) or initiates the device audio input to listen for the inputted username and user-requested authentication. As shown in FIG. 5C, the website may notify the user's mobile device or wearable device using a push notification. As shown in FIG. 5D, the user may activate a corresponding program on the mobile device which then sends authentication information via the authentication process to the device that is asking for the authentication information by (a) receiving a push notification, (b) activating the authentication process via biometrics on any mobile device or on a wearable device with a biometric sensor, and (c) the user authenticating the website's request for user authenticity. As shown in FIG. 5E, the website or device that the user is trying to access may then accept the authentication and allow user to pass through.

Synchronization is one method by which ambient or other non-informational signal interference can be highly attenuated. Synchronization of signals requires that the receiver and transmitter are, within a certain tolerance, in phase. The phase detection method is sensitive to the phase of a given signal and by extension, the frequency of the signal and the frequency expected at the receiver. This is true since two differing frequencies, the one transmitted and the one expected by the receiver will not be in sync, except for very brief and widely separated time intervals.

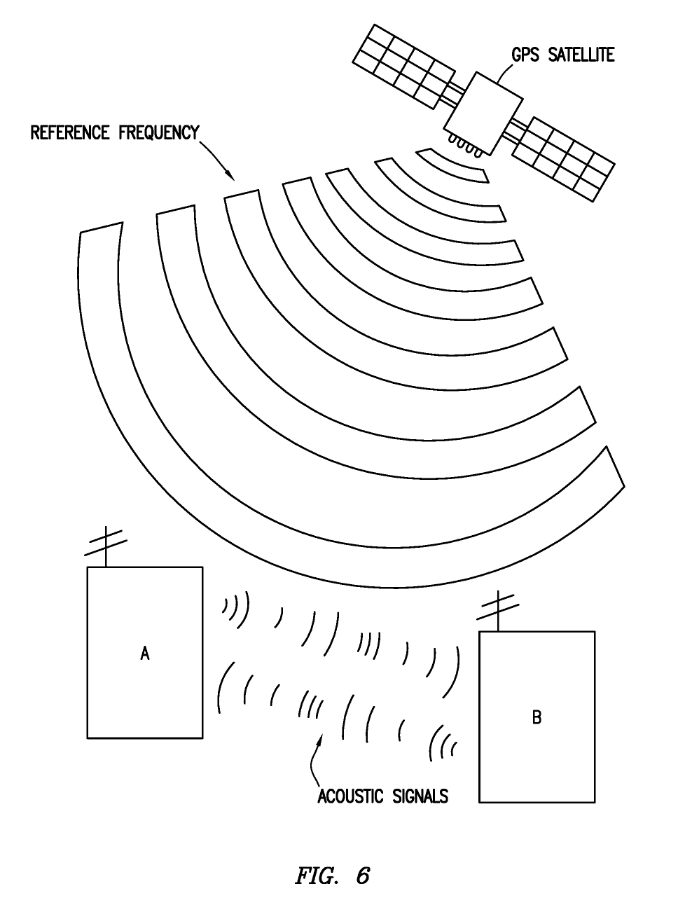

FIG. 6 illustrates how the receiver (A) and transmitter (B) collect their reference signal according to particular embodiments. Groups of GPS satellites, in concert may generate and transmit signals of reference frequencies. The GPS satellite group may use each of their individual atomic clocks to form an average standard reference frequency. One of these signals is an exquisitely accurate 1 Hz time tick. In particular embodiments, most communications devices may be able to receive this reference signal.

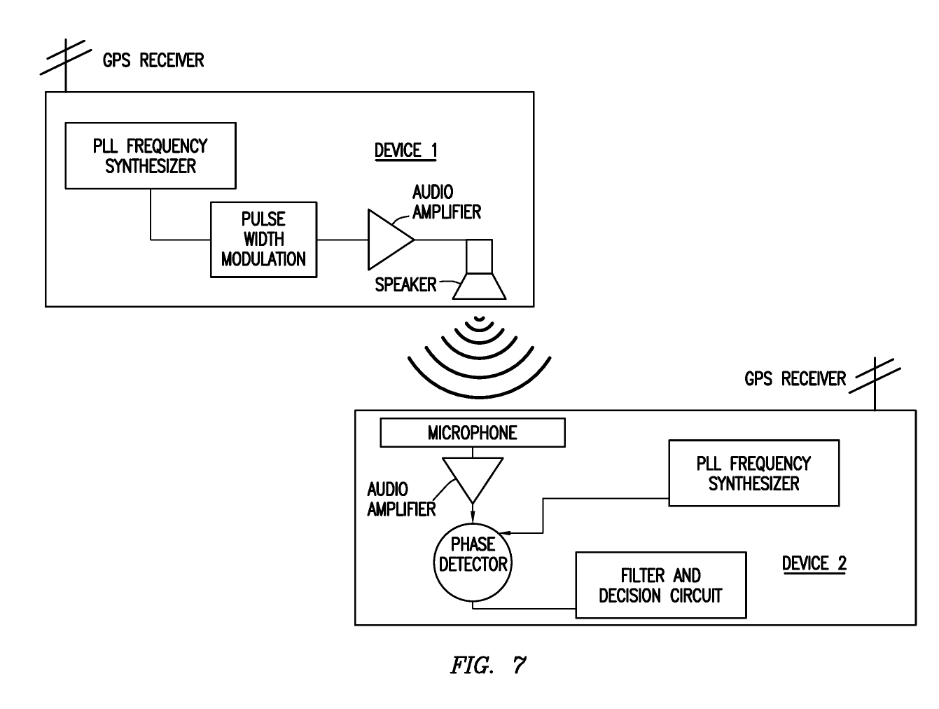

FIG. 7 illustrates an example basic synchronization process. Both communications Device 1 and Device 2 may utilize the 1 Hz reference signal as one of the phase comparator inputs to a phase-locked loop (“PLL”). The output of the PLL is digitally divided by the value of the reference frequency of interest. For example, if the reference frequency is to be 1000 Hz, the output of the PLL is divided by 1000. The output of the divider may be used as the second comparator input of the PLL. The output of the PLL before the divider is 1000 Hz since it is the product of the divisor and the first reference signal (e.g., 1 Hz). Since the PLL forces the two comparator inputs to remain in phase, the 1000 Hz reference frequency is locked in phase and frequency to the programmed multiple of the GPS satellite's 1 Hz reference. It is similar to a discriminator or ratio detector used in frequency demodulation or it could be a digital device, like an ‘Exclusive OR’ gate.

The receiver and transmitter may be much closer to one another than to the satellite. Therefore, the skew in arrival time, from the satellite to the two communication devices is essentially non-existent. This behavior assures that the communication devices receive the 1 Hz signal at the same time causing them to be synchronously (e.g., in time) locked with one another. Tone bursts and reference tones can be generated and detected at a specific frequency, phase and time by carrying out the predicate operations synchronously. In this regard the communication channel between devices operates as if a high-Q filter was interposed the receiver's detector and decoder. This effectively creates a virtual private channel between the communication devices. Any spurious signal, such as one generated environmentally, may be effectively ignored by the communication devices since it is uncorrelated with the synchronous channel properties. This ensures transmission and detection of only informational signals, since the probability of the spurious signal containing a perfectly synchronized signal may be extremely low. In particular embodiments, pulse width modulation and audio amplification may be handled by the native operating systems of the respective devices.

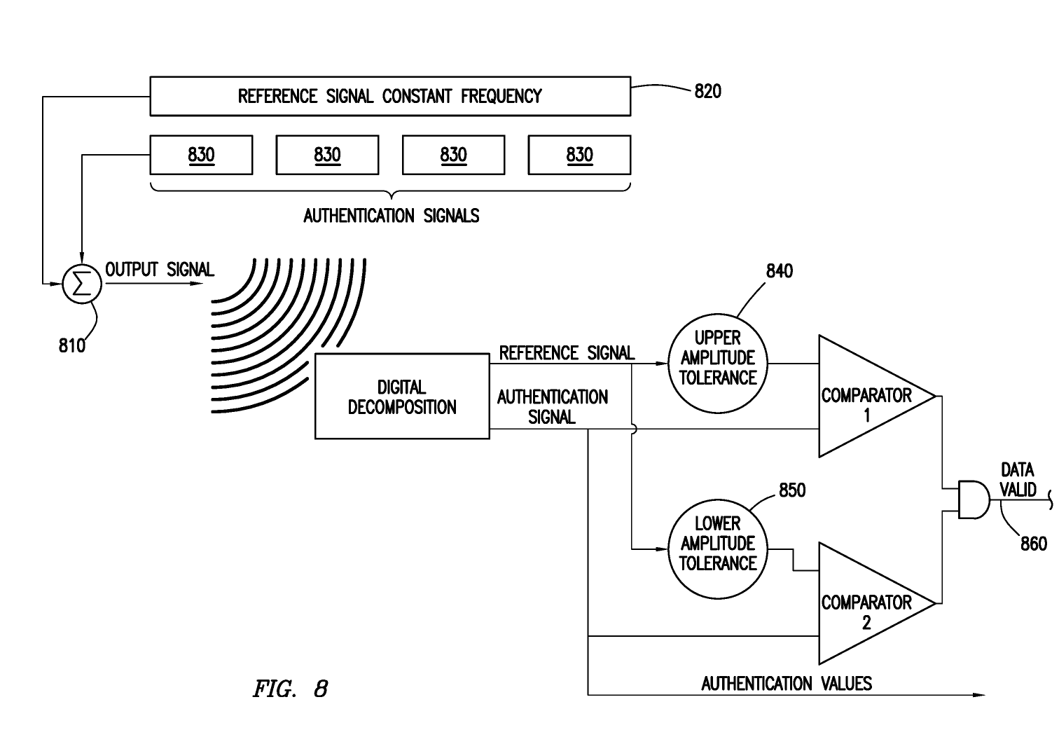

FIG. 8 illustrates an example method of transmitting and receiving authentication signals along with a reference signal. The assembled or summed output signal 810 to be transmitted may be the algebraic sum of a constant reference signal of a pre-selected frequency 820 and the authentication signals 830 that represent particular characters or numerical values. This summed signal 810 may be processed by the audio processor of the communication device and emitted by its speaker.

A microphone in the receiver communication device detects the signal 810, upon which the receiver communication device performs a digital decomposition in order to convert it into an electronic representation. The receiver may perform the digital decomposition by mathematically decomposing or detecting the contained frequencies and their amplitudes. The signal amplitude may be compared to an amplitude window. This amplitude window is defined by the amplitude of the reference signal adjusted for an upper tolerance limit 840 and lower tolerance limit 850 to compensate for variability in the reference signal and the authentication-signal bursts. The receiver communication device then transmits a signal 860 if the amplitude window has been satisfied. The software then checks if the frequency of the authentication signals are ones that the system recognizes. If not, the authentication signals are ignored. If so, the system further processes the mapping of the authentication signals' frequencies onto character or numerical values and responds accordingly.

This method increases the selectivity of the data exchange by several means. The method requires proper frequency, burst-duration and amplitude values to register the value as a valid authentication signal defined value or character. Each of the events in probability space, for a random external process, is linearly independent. This dictates that the probability that random processes will generate a spurious signal, identified as valid by the system, is the product of the probabilities of occurrence of each of the aforementioned values. In the off-chance that a random process is detected as a valid authentication signal, the probability of it being a valid authentication signal in the context of the full authentication signal string is small. This would cause a retransmit request, which would further reduce the compound error probability of the overall process.

Particular embodiments may securely transmit and receive data in the process of identification and validation of user or host credentials between two computing devices separated by a spatial gap. Particular embodiments may thereby enforce a minimum physical proximity of a person or a device to another person or device acting as an access point, and thereby may be resilient to out-of-room monitoring. The two computing devices may be separated by a spatial gap of up to 6 feet. Authentication may thus be restricted to taking place only within a predefined physical proximity, such as a maximum distance for a spatial gap. In particular embodiments, the maximum distance for the spatial gap may correspond to a radius of a circular region defined by a central point at which the access point is located.

In particular embodiments, the maximum distance for the spatial gap may be controlled programmatically for data transmitted using different means by increasing or decreasing a signal strength. Such programmatic control may comprise increasing or decreasing amplitude of sonic frequencies, increasing or decreasing the intensity of optical signals, or increasing or decreasing the power output of electromagnetic waves.

In particular embodiments, the identification data may comprise any combination of:
Human biometric and/or physiological/behavioral data;
Current location based on GPS or any other method to detect location;
Current time; or
Alphanumeric authentication code;

In particular embodiments, the receiving device may respond by generating handshaking signals to establish rules for communication according to a specified protocol.

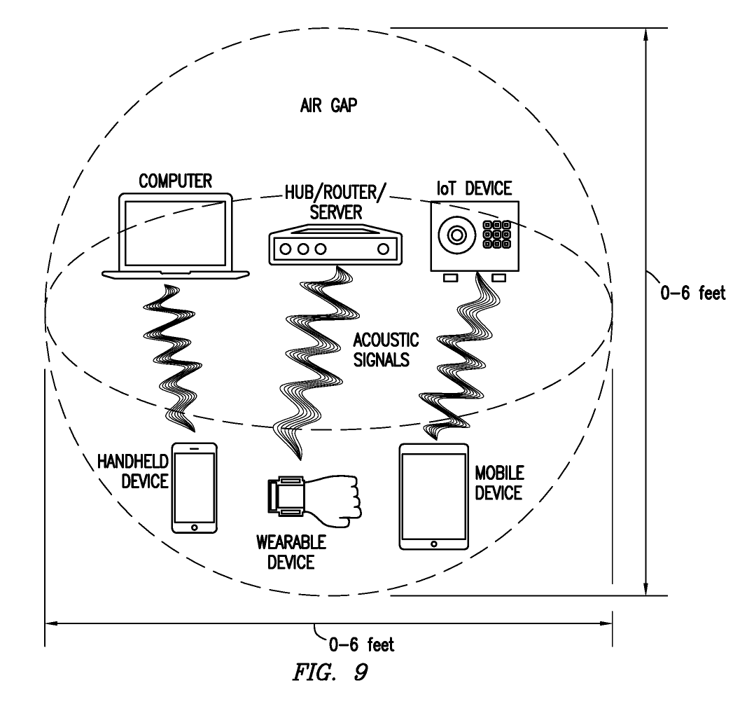

FIG. 9 is a schematic illustrating an authentication process using acoustic means within a defined spatial gap. In particular embodiments, authentication using such acoustic means may enable communication, and thereby authentication and/or authorization, to be restricted to take place only within an enclosed space. Such embodiments may differ from authentication systems using electromagnetic communications, which may pass through common building materials with ease.

In particular embodiments, the data may be transmitted using acoustical signals with air serving as the conveying medium for the spatial gap; in particular embodiments, the data transmissions may use frequencies less than or equal to 100 KHz. The signals may be acoustic pulses of variable or fixed durations. A data bit may be defined by the combination of one or more discrete frequencies. The data bits may be separated by periods of silence or some defined reference signal. The signals may be encoded as perturbations to normal sound. The data bits may be used in groups or packets to represent binary or encoded alphanumeric or symbol data. Some data bits may be reserved for synchronization and or flow control and/or error detection and/or correction.

In particular embodiments, the received frequencies may be different from the transmitted frequencies. The initially constructed data set may then be further processed by a mathematical transform. The transforming function may be chosen by the receiver, which transmits the receiver's choice to the device that will be sending the secure information.

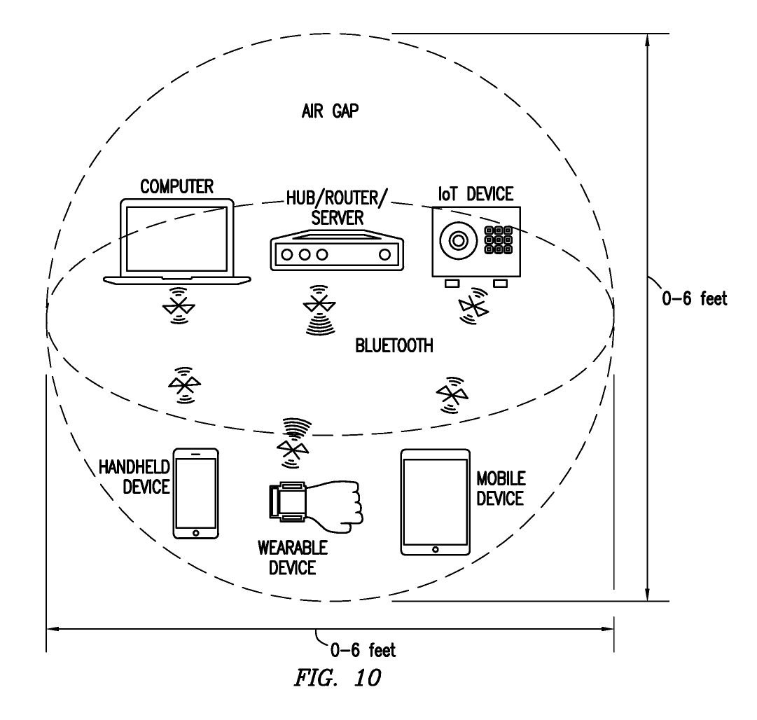

FIG. 10 is a schematic illustrating an authentication process using electromagnetic means within a defined spatial gap.

In particular embodiments, the data may be transmitted using electromagnetic signals with air serving as the conveying medium. The electromagnetic signal may be generated by a RF device (including but not limited to BLUETOOTH or WiFi) or an NFC (Near Field Communication) system.

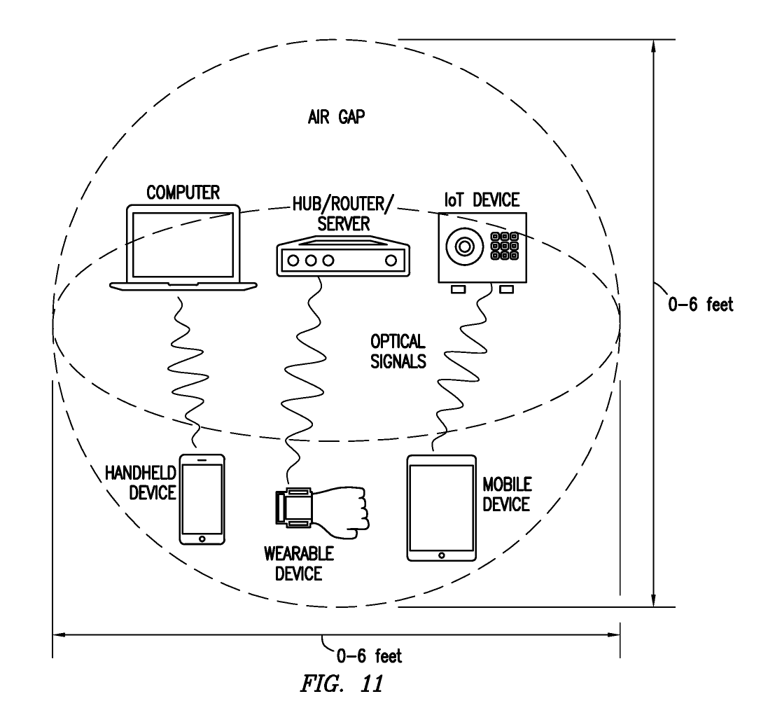

FIG. 11 is a schematic illustrating an authentication process using optical means within a defined spatial gap. In particular embodiments, authentication using such optical means may enable communication, and thereby authentication and/or authorization, to be restricted to take place only within an enclosed space. Such embodiments may differ from authentication systems using electromagnetic communications, which may pass through common building materials with ease.

In particular embodiments, the data may be transmitted using optical signals. The optical signal may be generated by an embedded flashlight or other light emitting device. The optical signal may be detected by an embedded camera or a camera, wired or wirelessly connected camera. The optical signal may use optical pulses with variable or fixed durations. The information may be encoded in amplitude of the optical pulse (including the modulation by toggling it on/off) or duration of the optical pulse.

In particular embodiments, a GPS location may be derived from an embedded GPS sensor. In particular embodiments, the GPS location may be derived from a previously constructed lookup table. The GPS lookup table may associate the current WiFi access point's SSID to the GPS location. The GPS location associated with a SSID, MAC, router, cell tower or any radio signal transmitter may be registered at the last successful login by reading the location from the connected GPS-enabled device in proximity.

In particular embodiments, the secure transmission of data using acoustic and/or optical means may be used to verify transactions including but not limited to credit card purchases, financial transactions, ATM transactions, and any other form of data interchange for financial transactions.

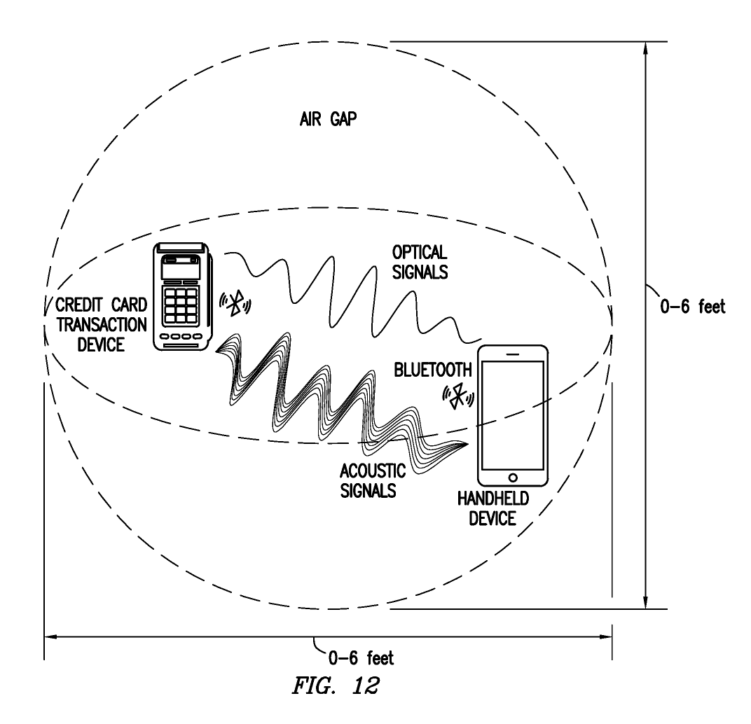

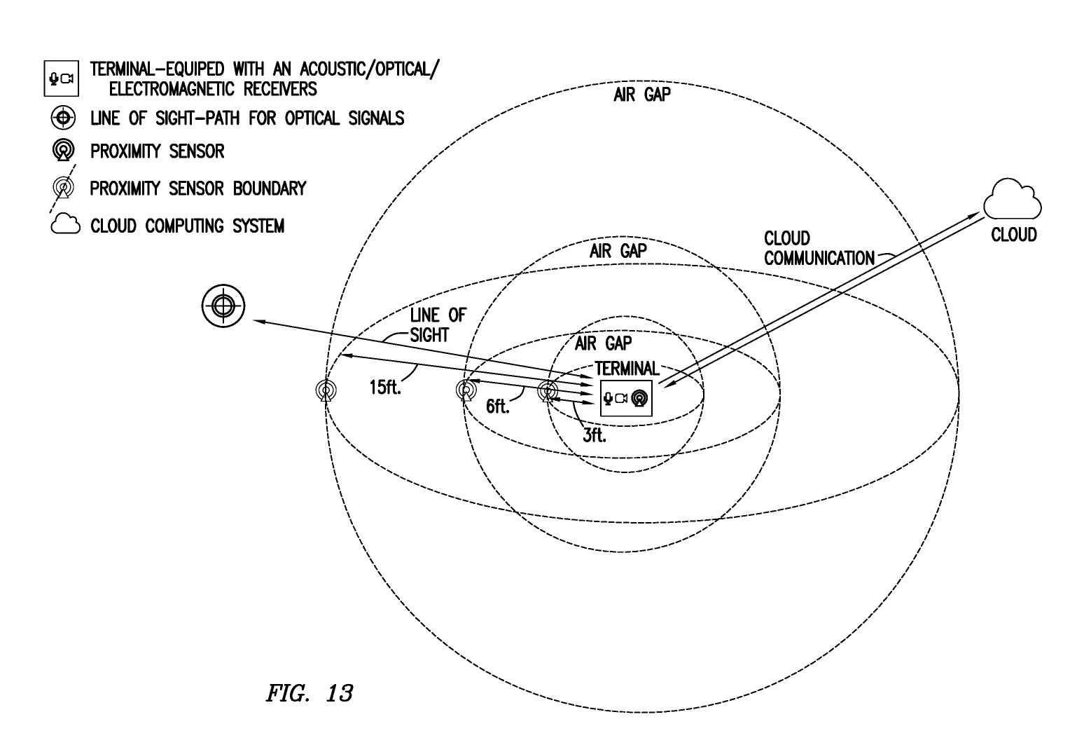

FIG. 12 is a schematic illustrating an authentication process using a mix of communications means within a defined spatial gap. In particular embodiments, electromagnetic signals may be used to establish communications by way of a handshake protocol, followed by authentication using optical and/or acoustic means. In particular embodiments, instead of manually entering a username, ID, and/or password authentication data may be sent via acoustic/optical/electromagnetic means—either individually or as a combination of two or more of the said means. This may be done without any manual input either at creation of the ID or subsequent requests to prove a user ID to an access point (e.g., ATM, online, physical access points). The user's mobile device may collect the identification information and transmit it when requested.

FIG. 13 is a schematic illustrating an authentication process taking place over layered spatial gaps. As shown in FIG. 13, various levels of communication, authentication, authorization, and/or other functionality or services may take place as a client device moves towards a terminal equipped with an acoustic, optical, and/or electromagnetic receiver and/or transmitter. As the client device moves into line-of-sight distance, authentication by optical means may become feasible, once the proximity of the client device to the terminal becomes sufficiently close to register light transmission intensity at a level that enables communication as described herein. As the client device moves closer such that it is within sufficient proximity to enable authentication by acoustic means at frequencies that are only detectable within 15 feet, 6 feet, and/or 3 feet, subsequent layers of communication, authentication, authorization, and/or other functionality or services may be enabled.

In particular embodiments, layered spatial gaps may use multiple means to ensure that a user is continuously near the access point and logs the user out if the user moves away from it for a defined period of time.

This may be achieved by using BLE or Acoustic to constantly ping between the user's phone and the access point. When the phone moves away from the access point to a distance beyond the reach of the pings, connectivity may be lost and the user may be logged out of a system.

In particular embodiments, instead of a User manually entering authentication information, such as a username, ID, and/or password, or personal preferences, such as device settings or environment settings into a Terminal to access or update a Secured System authentication data is provided by the User without any manual input. This data is communicated by their Mobile Device to the Terminal. The Mobile Device constantly collects User identification data, such as behavioral, biometric and geolocation data, and responds to authentication requests within various layered ‘Spatial gaps’. Secured, layered ‘Spatial gaps’ means that a User can automatically accept or deny authentication requests based on proximity. When a user enters a new ‘Spatial gap’ or a new environment the system or environment responds to the User, their authentication level and their personal preferences and settings.

When a user chooses to access a restricted system, they begin the access procedure by tapping their mobile device to begin the process. The tapping of the mobile device makes use of Electromagnetic means to process by establishing a handshake between the system and the mobile device. The user is then prompted for biometrics, at which time, when the biometrics are scanned, the mobile device begins transmitting the data to secure the spatial gap. Upon initial authentication data communication, the system is unlocked and becomes accessible to the user.

The session length depends on the security requirements of the system. A system may have one or many spatial gaps defined and a user may be authorized for one, many or all of the spatial gaps within the system. As such throughout the session the mobile device will act as a persistent link to the system and as soon as a specific spatial gap as defined by the system is unable to reach the mobile device, the session is ended, for that particular spatial gap. Any big interaction in the system requires the devices to authenticate the interaction so the system is secure all the time.

An example to demonstrate persistent links and layered spatial gaps is the example of a user's presence in a typical office, inside a typical multi-level office building, on a single level, with multiple office rooms. One spatial gap layer could be defined by the range of the Wi-Fi router network provided by the single floor of the office building. This range would typically extend to all spatial gaps within the confines of the building level, and up to 10 feet outside of the single level. When a user is connected to the specific Wi-Fi they have established that they are within the particular confines of that layered spatial gap. The same user may then be inside an enclosed office room, sitting next to a computer. The spatial gap surrounding the computer may be defined as the space up to 6 feet from the computer, within the confines of the office room walls. This spatial gap requires that the user's mobile device confirms its proximity by emitting sound waves at a high frequency which are not able to travel through the thick office walls. This demonstrates how a user can prove they are within a layered spatial gap by using various means.

In particular embodiments, a layered spatial gap may use multiple means to ensure that a user is continuously within a threshold proximity to the access point and may log the user out if the user moves away from the access point for a defined period of time. This is achieved by using BLE or Acoustic to constantly ping between the user's phone and the access point. When the phone is moved away from the access point to a distance beyond the reach of the pings, the connectivity is lost and a user is logged out of a system.

Particular embodiments may substantially improve the user experience of accessing restricted physical locations or systems that comprise of digital and/or mechanical components, herein referred to as a “restricted system.”

A typical implementation of the system and method described in the claims may include two key components: (1) a terminal, which may be visible or hidden and it may be a stand-alone feature or a feature that is incorporated into another physical component or digital software; and (2) a mobile device, such as a smartphone, tablet, smartwatch, IoT device, with mechanical and/or digital components, or any other device that is capable of capturing identification information and communicating with the terminal.

In physical implementations of the system and method, typically a third component, a mechanical component, would also be incorporated into the system. This mechanical component may be a lock, hinge or any other type of physical component that would modify the state of a physical component. It may be a physical layer such as a gate, door, latch, wall or any other component that encloses or restricts a physical space, or it may be an electronic component or a series of components whose state may be affected to achieve the purpose of restricting access. While most physical implementations will rely on mechanical and electronic components, the claims also extend to electromagnetic, light, sound, chemical and other components where a change in state may provide a change in granting or restricting access to a system.

A user may initiate authentication via a range of methods including: (1) Active Authentication—initiating the authentication may be known to the user and require their active involvement, (2) Passive Authentication—where the user is aware of the authentication but is only involved passively, or (2) Automatic Passive Authentication—where the user is passively involved in authentication and may not be aware that authentication is occurring.

Active Authentication may be summarized as any authentication experience where the user is directly and actively involved in the steps required to pass or fail the authentication requirements of the restricted system. An example is the authentication procedure of logging into a website on a computer (terminal) where the user must initiate the authentication by entering a username and clicking a button on the website. In the present system the user would then be required to prove their identity and to prove their proximity to the terminal using their mobile device.

Passive Authentication may be summarized as any authentication experience where the user is directly passively involved in the steps required to pass the authentication requirements of the restricted system. An example to demonstrate an improved user experience is the authentication procedure of logging into a website on a computer (terminal) where the user does not have to actively provide identity proof to pass the authentication requirements of the website. In the present system the mobile device would frequently capture proof of the user's identity without disrupting the user's experience of normal daily mobile device use, such as by capturing the fingerprint of the user when they are holding or touching their mobile device. This identification proof is thereby available without action by the user. In the current example when the website requires the user's proof of identity the mobile device may provide this proof without active involvement by the user and the mobile device may then prove the user's proximity to the terminal. This dramatically improves the user experience without compromising the security requirements of the system by eliminating many of the cumbersome steps in a typical multi-factor authentication system.

Automatic Passive Authentication may be summarized as any authentication experience where the user is completely passively involved in the steps required to pass the authentication requirements of the restricted system and they may or may not be aware that specific authentications are occurring. An example to demonstrate an improved user experience is the authentication procedure of entering a restricted physical location (a locked office door) and then automatically logging into a website on a computer (terminal) where the user does not have to actively provide identity proof to pass the authentication requirements of the website and does not have to actively initiate all authentication procedures. In the present system the mobile device would frequently capture proof of the user's identity without disrupting the user's experience of normal daily mobile device use, such as by capturing the fingerprint of the user when they are holding or touching their mobile device. This identification proof is thereby available without action by the user. The mobile device may also serve as a trigger to automatically initiate a series of authentication processes without requiring action by the user for any or all of the processes.

In the current example when the user successfully passes the authentication requirements of the restricted physical location (opens the locked office door) the system may know that the next normal behavior of the user is to login to a specific website. As the user's identity and authority information has already been provided to another part of the restricted system (the door lock) the system may then automatically seek proof of the user's physical proximity to the computer (terminal) by various means, such as by sending out a Bluetooth beacon. This beacon may include information regarding various authentication requests. When the mobile device detects the beacon, it may respond by emitting proof of proximity information (by emitting sound, light or electromagnetic signals) back to the computer. As the system knows the user is authenticated to be in the physical location and the computer now knows that the user is within a close proximity to the computer the computer can automatically log the user into the website. This multi-factor authentication sequence may be achieved without any active involvement by the user, without disruption to the user's normal mobile device user experience and without disrupting the normal physical movements of the user within the location. This dramatically improves the user experience without compromising the security requirements of the system by eliminating many, if not all, of the cumbersome steps in a typical multi-factor authentication system.

Particular embodiments described herein enable a way to seamlessly, automatically and passively modify a system or environment based on the presence of an individual. Particular embodiments described herein may be able to modify system and environment settings to match personal preferences or privileges just by the user being physically present in an environment. This is made possible by identifying a user using a mobile device, identifying a user's rights and permissions within a system, and/or by identifying the user's environment based on factors such as geolocation information, device and sensor data such as IoT device data, behavior patterns and direct and indirect user interactions with the environment or system.

Many systems and environments allow a user to set and save personal preferences. This provides a convenient way for a user to recall their ideal settings when returning to a device or environment. However most of these systems require that a user directly interacts with a device or environment prior to the device or environment responding to their personal preferences or privileges. Currently there is no convenient way to dynamically update and transfer personal settings and privileges across devices, systems and environments automatically, and to adjust the personalized experience accordingly for the user.

The claimed method and system provides a significantly improved user experience of personalizing an environment, device or system based on the user's identity and proximity to the environment, system or device.

Every time you set your personal preferences on any device/environment, they get stored and constantly get updated based on your behavior and real time preferences. Using particular embodiments described herein to authenticate identity may allow a user to have a personalized experience in any environment.

Particular embodiments may enable:
User authenticates ID in an environment actively or passively;
Users personal preferences are applied to that environment, to create a very personalized experience of the environment;
The environment responds to changes in user preferences and updates the user preferences for the environment and similar environments; or
User can manage changes.

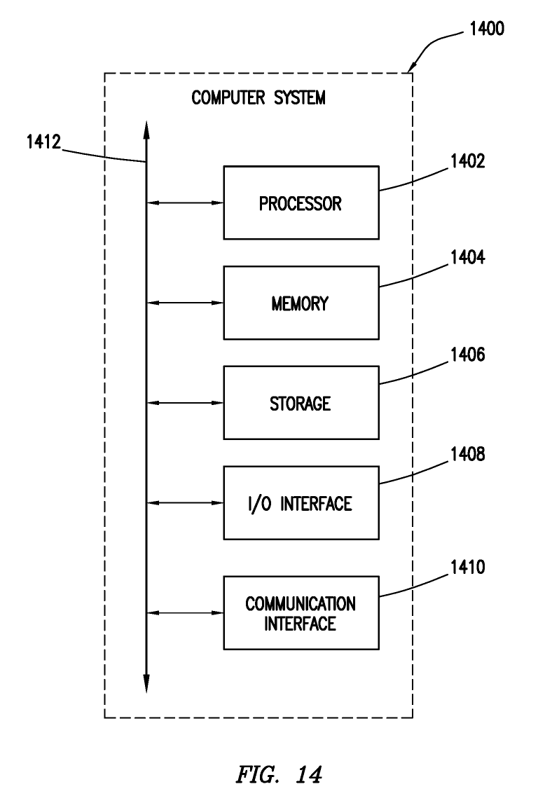

FIG. 14 illustrates an example computer system 1400. In particular embodiments, one or more computer systems 1400 perform one or more steps of one or more methods described or illustrated herein. In particular embodiments, one or more computer systems 1400 provide functionality described or illustrated herein. In particular embodiments, software running on one or more computer systems 1400 performs one or more steps of one or more methods described or illustrated herein or provides functionality described or illustrated herein. Particular embodiments include one or more portions of one or more computer systems 1400. Herein, reference to a computer system may encompass a computing device, and vice versa, where appropriate. Moreover, reference to a computer system may encompass one or more computer systems, where appropriate.

This disclosure contemplates any suitable number of computer systems 1400. This disclosure contemplates computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

In particular embodiments, computer system 1400 includes a processor 1402, memory 1404, storage 1406, an input/output (I/O) interface 1408, a communication interface 1410, and a bus 1412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage 1406; decode and execute them; and then write one or more results to an internal register, an internal cache, memory 1404, or storage 1406. In particular embodiments, processor 1402 may include one or more internal caches for data, instructions, or addresses. This disclosure contemplates processor 1402 including any suitable number of any suitable internal caches, where appropriate. As an example and not by way of limitation, processor 1402 may include one or more instruction caches, one or more data caches, and one or more translation lookaside buffers (TLBs). Instructions in the instruction caches may be copies of instructions in memory 1404 or storage 1406, and the instruction caches may speed up retrieval of those instructions by processor 1402. Data in the data caches may be copies of data in memory 1404 or storage 1406 for instructions executing at processor 1402 to operate on; the results of previous instructions executed at processor 1402 for access by subsequent instructions executing at processor 1402 or for writing to memory 1404 or storage 1406; or other suitable data. The data caches may speed up read or write operations by processor 1402. The TLBs may speed up virtual-address translation for processor 1402. In particular embodiments, processor 1402 may include one or more internal registers for data, instructions, or addresses. This disclosure contemplates processor 1402 including any suitable number of any suitable internal registers, where appropriate. Where appropriate, processor 1402 may include one or more arithmetic logic units (ALUs); be a multi-core processor; or include one or more processors 1402. Although this disclosure describes and illustrates a particular processor, this disclosure contemplates any suitable processor.

In particular embodiments, memory 1404 includes main memory for storing instructions for processor 1402 to execute or data for processor 1402 to operate on. As an example and not by way of limitation, computer system 1400 may load instructions from storage 1406 or another source (such as, for example, another computer system 1400) to memory 1404. Processor 1402 may then load the instructions from memory 1404 to an internal register or internal cache. To execute the instructions, processor 1402 may retrieve the instructions from the internal register or internal cache and decode them. During or after execution of the instructions, processor 1402 may write one or more results (which may be intermediate or final results) to the internal register or internal cache. Processor 1402 may then write one or more of those results to memory 1404. In particular embodiments, processor 1402 executes only instructions in one or more internal registers or internal caches or in memory 1404 (as opposed to storage 1406 or elsewhere) and operates only on data in one or more internal registers or internal caches or in memory 1404 (as opposed to storage 1406 or elsewhere). One or more memory buses (which may each include an address bus and a data bus) may couple processor 1402 to memory 1404. Bus 1412 may include one or more memory buses, as described below. In particular embodiments, one or more memory management units (MMUs) reside between processor 1402 and memory 1404 and facilitate accesses to memory 1404 requested by processor 1402. In particular embodiments, memory 1404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1404 may include one or more memories 1404, where appropriate. Although this disclosure describes and illustrates particular memory, this disclosure contemplates any suitable memory.

In particular embodiments, storage 1406 includes mass storage for data or instructions. As an example and not by way of limitation, storage 1406 may include a hard disk drive (HDD), a floppy disk drive, flash memory, an optical disc, a magneto-optical disc, magnetic tape, or a Universal Serial Bus (USB) drive or a combination of two or more of these. Storage 1406 may include removable or non-removable (or fixed) media, where appropriate. Storage 1406 may be internal or external to computer system 1400, where appropriate. In particular embodiments, storage 1406 is non-volatile, solid-state memory. In particular embodiments, storage 1406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1406 taking any suitable physical form. Storage 1406 may include one or more storage control units facilitating communication between processor 1402 and storage 1406, where appropriate. Where appropriate, storage 1406 may include one or more storages 1406. Although this disclosure describes and illustrates particular storage, this disclosure contemplates any suitable storage.

In particular embodiments, I/O interface 1408 includes hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1408 for them. Where appropriate, I/O interface 1408 may include one or more device or software drivers enabling processor 1402 to drive one or more of these I/O devices. I/O interface 1408 may include one or more I/O interfaces 1408, where appropriate. Although this disclosure describes and illustrates a particular I/O interface, this disclosure contemplates any suitable I/O interface.

In particular embodiments, communication interface 1410 includes hardware, software, or both providing one or more interfaces for communication (such as, for example, packet-based communication) between computer system 1400 and one or more other computer systems 1400 or one or more networks. As an example and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1410 for it. As an example and not by way of limitation, computer system 1400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1400 may include any suitable communication interface 1410 for any of these networks, where appropriate. Communication interface 1410 may include one or more communication interfaces 1410, where appropriate. Although this disclosure describes and illustrates a particular communication interface, this disclosure contemplates any suitable communication interface.

In particular embodiments, bus 1412 includes hardware, software, or both coupling components of computer system 1400 to each other. As an example and not by way of limitation, bus 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1412 may include one or more buses 1412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
by a first computing device, establishing a first spatial gap, wherein the first spatial gap is defined by a maximum distance from the first computing device for computing devices requesting validation of credentials;
by the first computing device, exchanging, with a second computing device, data transmissions to execute a handshake protocol, wherein the first computing device transmits communication signals at a specified signal strength, and wherein the specified signal strength is configured based on the maximum distance;
by the first computing device, determining that the second computing device remained within the first spatial gap throughout the handshake protocol; and
by the first computing device, granting access to the second computing device.

2. The method of claim 1, wherein the communication signals are transmitted by acoustic means of the first computing device, and wherein the maximum distance defining the first spatial gap is limited by an amplitude of a sonic frequency established by the acoustic means.

3. The method of claim 1, wherein the communication signals are transmitted by optical means of the first computing device, and wherein the maximum distance defining the first spatial gap is limited by an intensity of an optical frequency established by the acoustic means.

4. The method of claim 1, wherein the communication signals are transmitted by electromagnetic means of the first computing device, and wherein the maximum distance defining the first spatial gap is based on a power output of the electromagnetic means.

5. The method of claim 1, wherein the exchanging the data transmissions to execute a handshake protocol further comprises:
by the first computing device, transmitting signals to the second computing device, wherein the transmitted signals conform to a first set of signal parameters;
by the first computing device, receiving signals from the second computing device, wherein the transmitted signals conform to a second set of signal parameters; and
by the first computing device, transforming the received signals from the second computing device by applying a transforming function specified by the second computing device.

6. The method of claim 1, wherein the maximum distance defining the first spatial gap is restricted to a distance appropriate for capturing biometric identification information.

7. The method of claim 1, further comprising:
by the first computing device, establishing a second spatial gap, wherein the second spatial gap is defined by a maximum distance from the first computing device for computing devices requesting connectivity;
by the first computing device, determining that a third computing device previously granted access by the first computing device is no longer detectable within the second spatial gap; and
by the first computing device, terminating access to the third computing device.

8. An access point device comprising one or more processors and a memory coupled to the processors comprising instructions executable by the processors, the processors being operable when executing the instructions to:
establish a first spatial gap, wherein the first spatial gap is defined by a maximum distance from the access point device for client computing devices requesting validation of credentials;
exchange, with a client computing device, data transmissions to execute a handshake protocol, wherein the access point device transmits communication signals at a specified signal strength, and wherein the specified signal strength is configured based on the maximum distance;
determine that the client computing device remained within the first spatial gap throughout the handshake protocol; and
grant access to the client computing device.

9. The access point device of claim 1, wherein the communication signals are transmitted by acoustic means of the access point device, and wherein the maximum distance defining the first spatial gap is limited by an amplitude of a sonic frequency established by the acoustic means.

10. The access point device of claim 1, wherein the communication signals are transmitted by optical means of the access point device, and wherein the maximum distance defining the first spatial gap is limited by an intensity of an optical frequency established by the acoustic means.

11. The access point device of claim 1, wherein the communication signals are transmitted by electromagnetic means of the access point device, and wherein the maximum distance defining the first spatial gap is based on a power output of the electromagnetic means.

12. The access point device of claim 1, wherein the processors being operable when executing the instructions to exchange the data transmissions to execute a handshake protocol further comprises the processors being operable to:
transmit signals to the client computing device, wherein the transmitted signals conform to a first set of signal parameters;
receive signals from the client computing device, wherein the transmitted signals conform to a second set of signal parameters; and
transform the received signals from the client computing device by applying a transforming function specified by the client computing device.

13. The access point device of claim 1, wherein the maximum distance defining the first spatial gap is restricted to a distance appropriate for capturing biometric identification information.

14. The access point device of claim 1, wherein the processors are further operable when executing the instructions to:
establish a second spatial gap, wherein the second spatial gap is defined by a maximum distance from the access point device for computing devices requesting connectivity;
determine that a third computing device previously granted access by the access point device is no longer detectable within the second spatial gap; and
terminate access to the third computing device.

15. One or more computer-readable non-transitory storage media embodying software comprising instructions operable when executed by an access point device to:
establish a first spatial gap, wherein the first spatial gap is defined by a maximum distance from the access point device for client computing devices requesting validation of credentials;
exchange, with a client computing device, data transmissions to execute a handshake protocol, wherein the access point device transmits communication signals at a specified signal strength, and wherein the specified signal strength is configured based on the maximum distance;
determine that the client computing device remained within the first spatial gap throughout the handshake protocol; and
grant access to the client computing device.

16. The computer-readable non-transitory storage media of claim 15, wherein the communication signals are transmitted by acoustic means of the access point device, and wherein the maximum distance defining the first spatial gap is limited by an amplitude of a sonic frequency established by the acoustic means.

17. The computer-readable non-transitory storage media of claim 15, wherein the communication signals are transmitted by optical means of the access point device, and wherein the maximum distance defining the first spatial gap is limited by an intensity of an optical frequency established by the acoustic means.

18. The computer-readable non-transitory storage media of claim 15, wherein the communication signals are transmitted by electromagnetic means of the access point device, and wherein the maximum distance defining the first spatial gap is based on a power output of the electromagnetic means.

19. The computer-readable non-transitory storage media of claim 15, wherein software comprising instructions operable when executed by an access point device to exchange the data transmissions to execute a handshake protocol further comprises instructions operable when executed by an access point device to:
transmit signals to the client computing device, wherein the transmitted signals conform to a first set of signal parameters;
receive signals from the client computing device, wherein the transmitted signals conform to a second set of signal parameters; and
transform the received signals from the client computing device by applying a transforming function specified by the client computing device.

20. The computer-readable non-transitory storage media of claim 15, wherein the maximum distance defining the first spatial gap is restricted to a distance appropriate for capturing biometric identification information.
